(19) United States
(12) Patent Application Publication
(10) Pub. No.: US 2026/0025023 A1
(43) Pub. Date: Jan. 22, 2026

(54) METHOD TO RECTIFY A BATTERY DISCHARGE PROFILE OF A RECHARGEABLE BATTERY

(71) Applicant: Enpower Greentech, Inc., New York, NY (US)

(72) Inventors: Yang Wang, Ann Arbor, MI (US); Zhendong Hu, Ann Arbor, MI (US); Yong Che, Ann Arbor, MI (US)

(21) Appl. No.: 18/779,472

(22) Filed: Jul. 22, 2024

(51) Int. Cl. H02J 7/00; H01M 4/02; H01M 4/38; H01M 10/42; H02J 7/34

(52) U.S. Cl. CPC H02J 7/00711; H01M 4/382; H01M 10/425; H02J 7/345; H01M 2004/027; H01M 2010/4271; H02J 2207/20; H02J 2207/50

(57) ABSTRACT

Disclosed is a method to rectify the discharge profile of a rechargeable battery so that the discharge current is greater than the charge current. The method includes two steps. The first step is an intermittent or pulsed discharge current protocol. It assures that the pulse discharge current is always higher than the charge current while the nominal discharge current is lower than the charge current. The second step includes a converter, that is used to convert the pulsed discharge current profile from the rechargeable battery into a continuous discharge current profile wherein the continuous current is smaller than the rechargeable battery charge current. The disclosed rectification method enables the rechargeable battery to power a device at an optimally lower rate for a certain applications with a significantly extended cycle life for the rechargeable battery.

### CROSS REFERENCE TO RELATED APPLICATIONS

None.

### FIELD OF THE DISCLOSURE

This disclosure relates generally to energy storage systems, and more particularly to rechargeable battery charge and discharge rate optimization.

### BACKGROUND OF THE DISCLOSURE

This section provides background information which is not necessarily prior art to the present disclosure.

The field of electrochemical energy storage has seen significant advancements in recent years, particularly in the development of rechargeable batteries for storing energy and powering devices. Because of their intrinsic properties, a certain type of battery can provide a high energy density but requires a discharge current that is higher than its charge current to maintain a long cycle life.

One representative example of these types of batteries are lithium metal anode batteries (LMBs). An LMB offers a high energy density of up to 500 W-h/kg, that is superior to the widely used lithium-ion and lead-acid batteries, which typically give an energy density at 200 and 40 W-h/kg, respectively. However, LMBs require their discharge current to be 1.3-5 times higher than their charge current to achieve a long cycle life. This requirement hinders the widespread adoption of LMBs, as it limits the types of applications that they can be used in. For example, people prefer to be able to charge their battery electric vehicles (BEVs) in a short time (10˜20 min) and then drive the BEV in a normal way for hours. If used in this way in the BEV, the LMBs will have an undesired short cycle life. One hypothesis of the failure mechanism of LMBs is that the slow removal of lithium from the lithium metal anode during the slow discharge of an LMB can cause uneven stripping, leading to localized areas where lithium is removed more quickly than others, creating pits and irregularities on the surface. These pits can serve as nucleation sites for dendrite growth during subsequent deposition cycles. This suggests that an LMB needs to discharge at a relatively higher current after being charged to maintain its longevity.

### SUMMARY OF THE DISCLOSURE

This section provides a general summary of the present disclosure and is not intended to be interpreted as a comprehensive disclosure of its full scope or all features, aspects, and objectives.

Disclosed herein is a battery discharge current rectification method, comprising two steps: the secondary battery is discharged in an intermittent pulsed current manner, wherein the pulse discharge current is higher than the battery charge current; and then the intermittent pulsed current is rectified by a converter to generate a continuous current output, which is lower than the battery's charge current.

### BRIEF DESCRIPTION OF THE DRAWINGS

The drawings described herein are for illustrative purposes only of selected aspects and not all implementations and are not intended to limit the present disclosure to only that actually shown. With this in mind, various features and advantages of example aspects of the present disclosure will become apparent to one processing ordinary skill in the art from the following written description and appended claims when considered in combination with the appended drawings, in which:

FIG. 1 is a schematic diagram illustrating the two-step battery discharge current rectification method of the present disclosure;

FIG. 2A illustrates the voltage and current profiles of a lithium metal anode battery that is under a continuous charge and a continuous discharge cycle not in accordance with the present disclosure;

FIG. 2B illustrates the voltage and current profiles of a lithium metal anode battery under a continuous charge with a pulsed discharge in accordance with the present disclosure;

FIG. 2C is an expanded view of the circled segment of FIG. 2B;

FIG. 3 is a plot comparing the cycle life of a lithium metal anode battery under the traditional continuous discharge method as shown in FIG. 2A versus the cycle life of a lithium metal anode battery under the pulsed discharge method of FIG. 2B according to the present disclosure;

FIG. 4 is a diagram of an embodiment of a converter according to the present disclosure composed of a boost converter, a super capacitor and a buck converter; and

FIG. 5 is a flow chart of an embodiment of the disclosed method.

### DETAILED DESCRIPTION OF THE DISCLOSURE

In the following description, details are set forth to provide an understanding of the present disclosure.

For clarity purposes, example aspects are discussed herein to convey the scope of the disclosure to those skilled in the relevant art. Numerous specific details are set forth such as examples of specific components, devices, and methods, to provide a thorough understanding of various aspects of the present disclosure. It will be apparent to those skilled in the art that specific details need not be discussed herein, such as well-known processes, well-known device structures, and well-known technologies, as they are already well understood by those skilled in the art, and that example embodiments may be embodied in many different forms and that neither should be construed to limit the scope of the disclosure.

The terminology used herein is for the purpose of describing particular example aspects only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or feature is referred to as being “on,” “connected to,” “coupled to” “operably connected to” or “in operable communication with” another element or feature, it may be directly on, engaged, connected, or coupled to the other element or layer, or intervening elements or features may be present. In contrast, when an element is referred to as being “directly on”, “directly engaged to”, “directly connected to”, or “directly coupled to” another element or feature, there may be no intervening elements or layers present between them. Other words used to describe the relationship between elements should be interpreted in a like fashion (e.g., “between” versus “directly between”, “adjacent” versus “directly adjacent”, etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second”, and other numerical terms when used herein do not imply a sequence or order unless clearly and expressly indicated by the context. Thus, a first element, component, region, layer, or section discussed below could be termed a second element, component, region, layer, or section without departing from the teachings of the example embodiments.

For purposes of description herein, the terms “upper”, “lower”, “right”, “left”, “rear”, “front”, “vertical”, “horizontal”, and derivatives thereof shall relate to the invention as oriented in the FIGS. However, it is to be understood that the present disclosure may assume various alternative orientations and step sequences, except where expressly specified to the contrary. It is also to be understood that the specific devices and processes illustrated in the attached drawings, and described in the following specification are exemplary aspects of the inventive concepts defined in the appended claims. Hence, specific dimensions and other physical characteristics relating to the aspects disclosed herein are not to be considered as limiting, unless the claims expressly state otherwise.

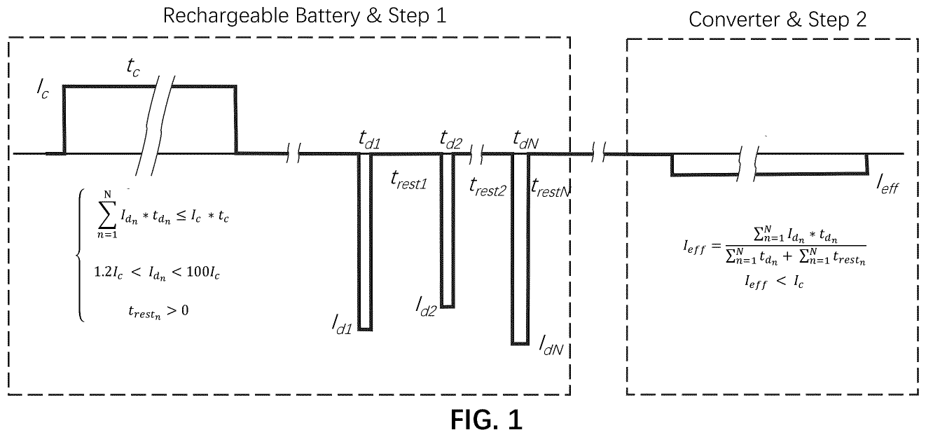

The two-step method of discharge current rectification is demonstrated in FIG. 1. The first step is a charge/discharge protocol applied to a rechargeable battery. The rechargeable battery is charged at a current I_{c} for a certain time the and the charged capacity is I_{c}*t_{c}. The discharge step comprises a plurality of pulsed discharge currents. The discharge current, pulse duration and rest time between pulses for the n-th pulse are labelled as I_{dn}, t_{dn} and tᵣₑₛₜₙ, respectively, in FIG. 1. The rechargeable battery useable in this disclosure is a specific type of rechargeable battery wherein the discharge current of the battery is higher than the charge current of the battery to maintain a long cycle life for the battery. The suitable rechargeable battery can be a metal anode battery, such as an LMB or it can be an anode-free battery. An anode free battery, as known to one of skill in the art, is one wherein the battery cell is initially formed without an anode active material, instead it has an anode current collector. The first time the battery cell is charged it creates its own anode on the current collector. Suitable current collectors for anode-free battery cells can comprise copper, titanium, aluminum, nickel, stainless steel, conductive polymers, and conductive polymer coated metal foils. Examples of conductive polymers that can be suitable include polyaniline (PANI), polydopamine (PDA), poly(3,4-ethylenedioxythiophene) polystyrene sulfonate (PEDOT:PSS), poly(para-phenylene) (PPP), polyacetylene (PA), poly(phenylenevinylene) (PPV), polypyrrole (PPy), polythiopnene (PTH), polyisothianaphthalene, polyfuran (PF) and mixtures thereof. The candidates for metals to be used as the anode material in metal anode batteries can include, for example, lithium, sodium, potassium, magnesium and zinc. In the rechargeable battery of the present disclosure the cathode material may comprise any of a variety of materials including, by way of example, lithium nickel cobalt aluminum oxide (NCA); lithium nickel manganese cobalt oxide (NMC); lithium iron phosphate; layered structures of lithium and metal oxides; spinel forms of lithium and metal oxides; olivine forms of lithium metal oxides; cation-disordered rocksalt (DRX) materials; lithium and mixed metal phosphates; sulfur or sulfur containing compounds, and mixtures thereof. As known by those of skill in the art the DRX cathodes have a general formula of LiₓTM₍₂₋ₓ₎O₂, wherein TM represents one or more transition metals from groups 3 to 12 of the Periodic Table and 0≤x≤2. Some examples of DRX cathodes include Li_{1.25}Nb_{0.25}Mn_{0.5}O₂; Li_{1.25}Ti_{0.4}Fe_{0.4}O₂; Li_{1.2}Ti_{0.4}Mn_{0.4}O₂; and Li_{1.25}Nb_{0.25}V_{0.5}O₂. The rechargeable battery in this disclosure can be a single cell; a battery module, which is a unit comprising a plurality of battery cells; or a battery pack comprising a plurality of battery modules controlled by battery management system (BMS).

The discharge current (I_{dn}) of the suitable rechargeable battery is 1.2˜100 times greater that its charge current (I_{c}). The I_{dn}, t_{dn}, and tᵣₑₛₜₙ among all the discharge pulse periods can be the same or different. The accumulated discharge capacity should be no larger than the charge capacity. The confinements on I_{c}, t_{c}, I_{dn}, t_{dn} and tᵣₑₛₜₙ are given as:

$$\{ \begin{matrix}{\sum }_{n = 1}^{N} {I}_{{d}_{n}} * {t}_{{d}_{n}} \leq {I}_{c} * {t}_{c} \\ 1.2 {I}_{c} < {I}_{dn} < 100 {I}_{c} \\ {t}_{{rest}_{n}} > 0\end{matrix}$$

The second step of the present method includes a converter, which converts the intermittent/pulsed discharge current profile from the rechargeable battery into a continuous

$${I}_{eff} = \frac{{\sum }_{n = 1}^{N} {I}_{{d}_{n}} * {t}_{{d}_{n}}}{{\sum }_{n = 1}^{N} {t}_{{d}_{n}} + {\sum }_{n = 1}^{N} {t}_{{rest}_{n}}}$$

current output I_{eff}. The current output I_{eff} is smaller than the battery charge current I_{c}, and is defined as

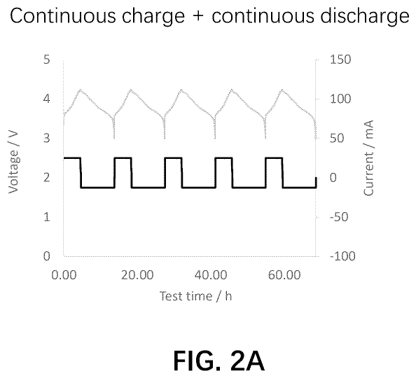

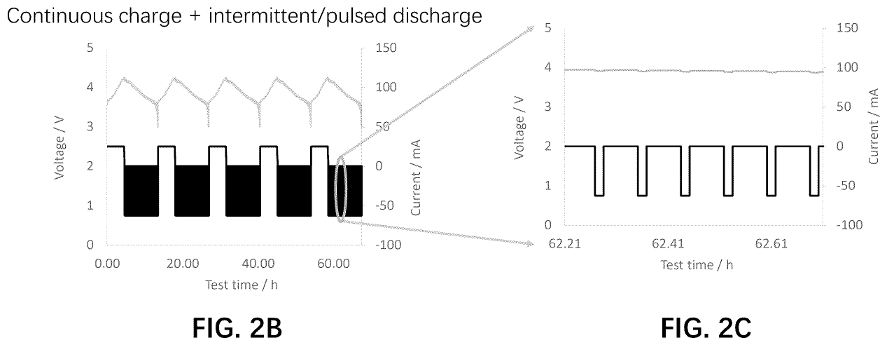

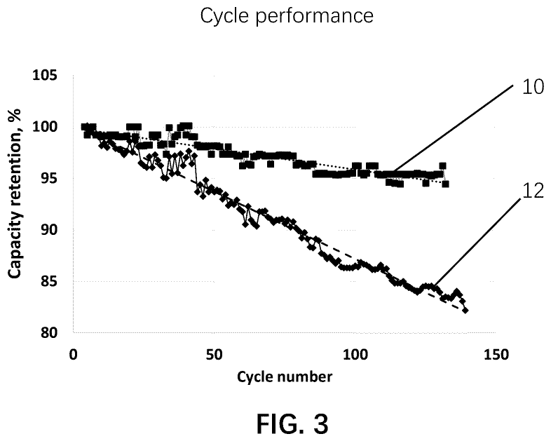

The disclosed charge/discharge protocol in step 1 of FIG. 1 is demonstrated to improve the battery cycle life significantly as shown in comparing the results of FIGS. 2A to 2B and 2C and in the data shown in FIG. 3. Two rechargeable batteries were each charged at a continuous current of 25 mA (0.2C charge rate). The first battery was discharged at 12.5 mA, 0.1C discharge current, in a typical continuous discharge fashion and the results are shown in FIG. 2A. In FIG. 2A the upper line represents the voltage in Volts as shown on the left Y-axis and the lower line represents the current in milliamps (mA) as shown on the right Y-axis. In this example, not in accordance with the present disclosure, both the charging and the discharging were continuous events as is traditional. The results for a second rechargeable battery, in accordance with the present disclosure, are shown in FIGS. 2B and 2C. For the second battery the charging was the same as in FIG. 2A and was continuous; however, the discharging was done in an intermittent/pulsed fashion as shown in FIG. 2C, which is an enlargement of a section of FIG. 2B to show the pulses. To make it similar and simple the discharge current for the second rechargeable battery shown in FIGS. 2B and 2C was discharged using periodic pulses with 62.5 mAh (0.5C) current, 1 minute pulse duration and 4 minutes resting time between pulses. Thus, the nominal discharge rate for the second battery was 0.1C, the same as for the first battery. One can see for the results shown in FIG. 3 that the capacity retention is improved significantly with the intermittent discharge current protocol of FIG. 2B, 2C in accordance with the present disclosure compared to the typical continuous charge and continuous discharge protocol not in accordance with the present disclosure. The results for the intermittent discharge current protocol are shown in line 10 and those for the continuous charge and discharge are shown in line 12. The battery subjected to the intermittent/pulsed discharge protocol maintains capacity retention above 95% after 100 cycles while the retention of the first battery, not in accordance with the present disclosure, dropped to 86% capacity retention at the 100^{th} cycle.

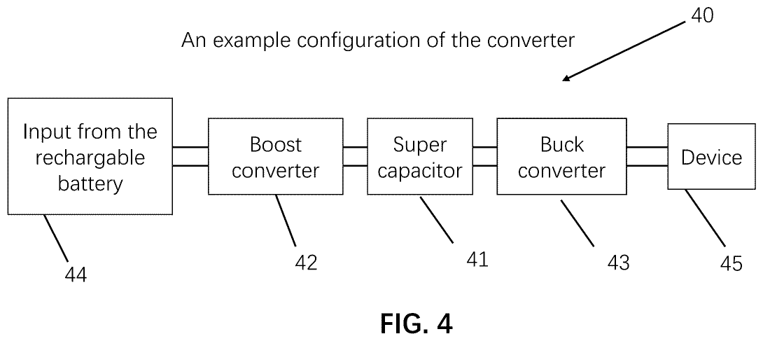

In the second step of the present disclosure the pulsed discharge current is converted into a continuous current output I_{eff} as discussed above. This is accomplished by a converter. An example of a converter configuration 40 is shown in FIG. 4. The converter configuration 40 takes the pulsed discharge current input 44 from the rechargeable battery and passes it to a boost converter 44, which passes it to a super capacitor 41, that in turn passes it to a buck convertor 43 and then the current is delivered to the end device 45. The super capacitor 41 in the second step could be replaced by a rechargeable battery with no restriction on the discharge to charge current ratio, an electrochemical capacitor, a lithium-ion capacitor, or any other type of super capacitor, all of which can be charged at a higher rate and can be discharged at a slower rate. These types of super capacitors can be subjected to many more cycles of charge/discharge than a rechargeable battery and their charge and discharge currents are much faster than for a rechargeable battery. The input voltage from the rechargeable battery 44 is boosted upward by the boost converter 42 to charge the super capacitor 41 until it reaches a predetermined voltage V_{sc-max}. When the super capacitor 41 powers the device 45, the voltage is bucked down by the buck converter 43 prior to being passed to the device 45, and the output current I_{eff} from the buck convertor 43 is continuous and smaller than the rechargeable battery charger current I_{c}.

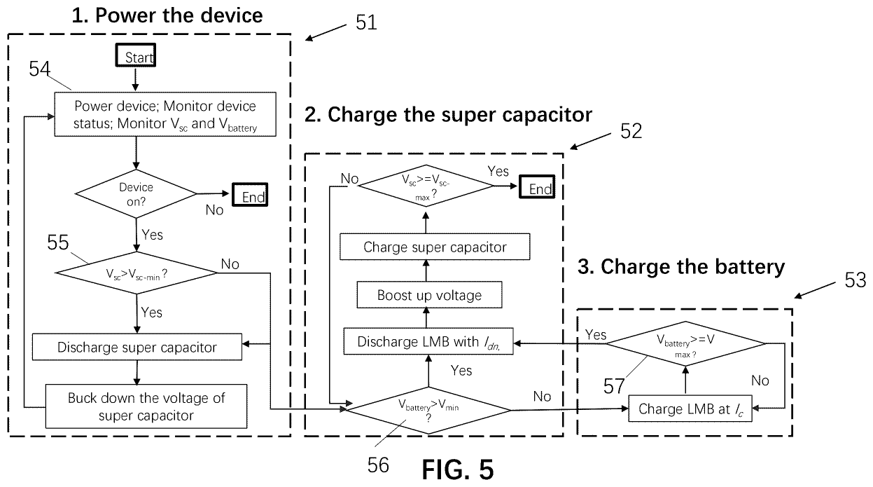

An example flow chart of the steps of powering a device 51, charging the super capacitor 52 and charging the rechargeable battery 53 is shown in FIG. 5. Once the device 45 is turned on in step 54, its status, the capacitor voltage (V_{sc}) and the battery voltage (V_{battery}) are monitored. The device 45 is powered by the capacitor 41 only when V_{sc} is larger than a pre-defined value V_{sc-min} as shown in step 55. Otherwise, the super capacitor charging 52 or the battery charging 53 step will be involved. The latter step 55 will be triggered when V_{battery} is smaller than a pre-defined value Vₘᵢₙ shown in step 56. Since the battery charging current (I_{c}) is larger than the output current I_{eff} in the disclosed method protocol the battery always puts more energy into the super capacitor 41 than the energy consumed by the device 45. Therefore, the device 45 will be continuously powered by the super capacitor 41 even if the super capacitor 41 is in the charging step 52.

The foregoing disclosure has been described in accordance with the relevant legal standards, thus the description is exemplary rather than limiting in nature. Variations and modifications to the disclosed embodiment may become apparent to those skilled in the art and do come within the scope of the disclosure. Accordingly, the scope of legal protection afforded this disclosure can only be determined by studying the following claims.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

We claim:

1. A battery discharge current rectification method for a rechargeable battery comprising the steps of:
a. providing a rechargeable battery;
b. discharging the rechargeable battery in a plurality of pulsed discharge currents wherein the pulse discharge current is from 1.2 to 100 times greater than a charge current used to charge the rechargeable battery; and
c. converting the plurality of pulsed discharge currents into a continuous current.

2. The battery discharge current rectification method for a rechargeable battery according to claim 1, wherein at least one of a pulse duration, a pulse discharge current, or a rest time between pulses in the plurality of pulsed discharge currents is the same for a plurality of the pulses.

3. The battery discharge current rectification method for a rechargeable battery according to claim 1, wherein at least one of a pulse duration, a pulse discharge current, or a rest time between pulses varies for a plurality of the pulses.

4. The battery discharge current rectification method for a rechargeable battery according to claim 1, wherein the rechargeable battery is selected from the group consisting of a metal anode battery and an anode-free battery.

5. The battery discharge current rectification method for a rechargeable battery according to claim 4, wherein the metal anode of the rechargeable battery is selected from the group consisting of lithium, sodium, potassium, magnesium, and zinc.

6. The battery discharge current rectification method for a rechargeable battery according to claim 4, wherein the rechargeable battery is an anode-free battery having a current collector selected from the group consisting of copper, titanium, aluminum, nickel, stainless steel, conductive polymers, and conductive polymer coated metal foils.

7. The battery discharge current rectification method for a rechargeable battery according to claim 6, wherein the conductive polymers are selected from the group consisting of polyaniline (PANI), polydopamine (PDA), poly(3,4-ethylenedioxythiophene) polystyrene sulfonate (PEDOT:PSS), poly(para-phenylene) (PPP), polyacetylene (PA), poly(phenylenevinylene) (PPV), polypyrrole (PPy), polythiopnene (PTH), polyisothianaphthalene, polyfuran (PF) and mixtures thereof.

8. The battery discharge current rectification method for a rechargeable battery according to claim 1, wherein the rechargeable battery has a cathode formed from lithium nickel cobalt aluminum oxide (NCA); lithium nickel manganese cobalt oxide (NMC); lithium iron phosphate; layered structures of lithium and metal oxides; spinel forms of lithium and metal oxides; olivine forms of lithium metal oxides; cation-disordered rocksalt (DRX) materials; lithium and mixed metal phosphates; sulfur or sulfur containing compounds, and mixtures thereof.

9. The battery discharge current rectification method for rechargeable battery according to claim 1, wherein the rechargeable battery comprises a single cell, a battery module or a battery pack.

10. The battery discharge current rectification method for a rechargeable battery according to claim 9, wherein the rechargeable battery is controlled by battery management system.

11. The battery discharge current rectification method for a rechargeable battery according to claim 1, wherein step c. comprises providing a converter that provides the continuous current at a current that is smaller than the rechargeable battery charge current.

12. The two-step battery discharge current rectification method according to claim 11, wherein the converter comprises a rechargeable battery with no restriction on its discharge to charge current ratio, an electrochemical capacitor, a lithium-ion capacitor, or a super capacitor, wherein each type of capacitor can be charged at a higher rate than it can be discharged.
